(19) United States
(12) Patent Application Publication
(10) Pub. No.: US 2009/0151424 A1
(43) Pub. Date: Jun. 18, 2009

(54) Structure of a detecting and measuring device

(76) Inventors: Chin-Ying Huang, Taichung City (TW); Hsin-Ming Huang, Taichung City (TW); Johnson Yen, Dali City (TW); Yen-Jen Yeh, Dounan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/000,347

(22) Filed: Dec. 12, 2007

(51) Int. Cl. G01N 37/00

(52) U.S. Cl. 73/23.2

(57) ABSTRACT

A detecting and measuring device includes a base member, a circuit board secured on the base member, and a covering member secured on the base member to cover the circuit board; the circuit board has a detecting and measuring component fitted on a middle portion thereof; the detecting and measuring component is easily replaceable, and it is used to detect and measure oxygen concentration and other data; a power supply and a wireless communication module are connected to the detecting and measuring component; in use, the detecting and measuring component will continue detecting and measuring oxygen concentration and other data in the surroundings, and the wireless communication module will continue transferring the data obtained through the detecting and measuring component so that a person can receive the data by means of internet in other places or with a wireless communication device such as a cellular phone at a distance away.

### BACKGROUND OF THE INVENTION

1. Field of the Invention

The present invention relates to a detecting and measuring device, more particularly one, which is equipped with a wireless communication module to make the device easy to assemble, install and maintain, and to allow the user to monitor oxygen concentration and other data of several different places simultaneously while he is in a distant place.

2. Brief Description of the Prior Art

Oxygen is among the most important chemical elements of the Earth. Oxygen forms approximately one fifth of the Earth's atmosphere. And, many oxygen elements are found in rocks and sand on the surface of the Earth. It is odorless and invisible and is essential to all living things.

To prevent workers from being harmed owing to lack of oxygen in factories, the labor safety and hygiene laws stipulate that oxygen concentration has to be higher than eighteen percent (the stipulated threshold value), and proper ventilation should be ensured in those working places where the oxygen concentration is prone to reduce. And, appropriate detecting and measuring devices should be installed in such places to monitor the oxygen concentration in the air, and to detect pernicious gases such as Hydrogen-sulfide.

A currently existing oxygen detecting and measuring device includes a shell, a circuit board secured in the shell, and a detecting and measuring component fitted on the circuit board. The above detecting and measuring device is found to have the following drawbacks:

1. The device has to be connected to a computer through a wired system such as connecting lines/internet interfaces so that the user can use the computer to receive and process the oxygen concentration data obtained through the device. Consequently, relatively much hardware is used, and it takes relatively much expense to install and maintain the above device.

2. A person has to stay in the place where the device is installed to monitor the oxygen concentration data obtained through the device. In other words, when several such devices are installed and used in different places, there will have to be one person to stay in each of the different places. Therefore, it takes much personnel cost to use the above device.

### SUMMARY OF THE INVENTION

It is an object of the present invention to provide an improvement on a detecting and measuring device, which comprises a wireless communication module to take the place of a wired system; thus, less hardware is used, and it takes less expense to manufacture, install and maintain the present detecting and measuring device.

A detecting and measuring device according to an embodiment of the present invention includes a base member, a circuit board secured on the base member, and a covering member secured on the base member; the circuit board has a detecting and measuring component fitted on a middle portion thereof, which is replaceable, and connected to a power supply and a wireless communication module.

The detecting and measuring device further includes a light source, e.g. light emitting diodes, to emit light to indicate the current working condition of the device.

The covering member of the present device has an opening, and a movable lid fitted on the opening in a movable manner; thus, the user is allowed to replace the detecting and measuring component on the circuit board through the opening.

The movable lid of the preset invention has an opening for air to travel through so that the detecting and measuring component can carry out a measuring task without any obstacle.

### BRIEF DESCRIPTION OF THE DRAWINGS

The present invention will be better understood by referring to the accompanying drawings, wherein:

FIG. 1 is an exploded perspective view of a first preferred embodiment of the present invention,

FIG. 2 is a block diagram of the circuit of the first preferred embodiment,

FIG. 3 is a circuit diagram of the first preferred embodiment,

FIG. 4 is a top view of the first preferred embodiment,

FIG. 5 is view of the first preferred embodiment being in use, and

FIG. 6 is an exploded perspective view of a second preferred embodiment of the present invention.

### DETAILED DESCRIPTION OF THE PREFERRED EMBODIMENTS

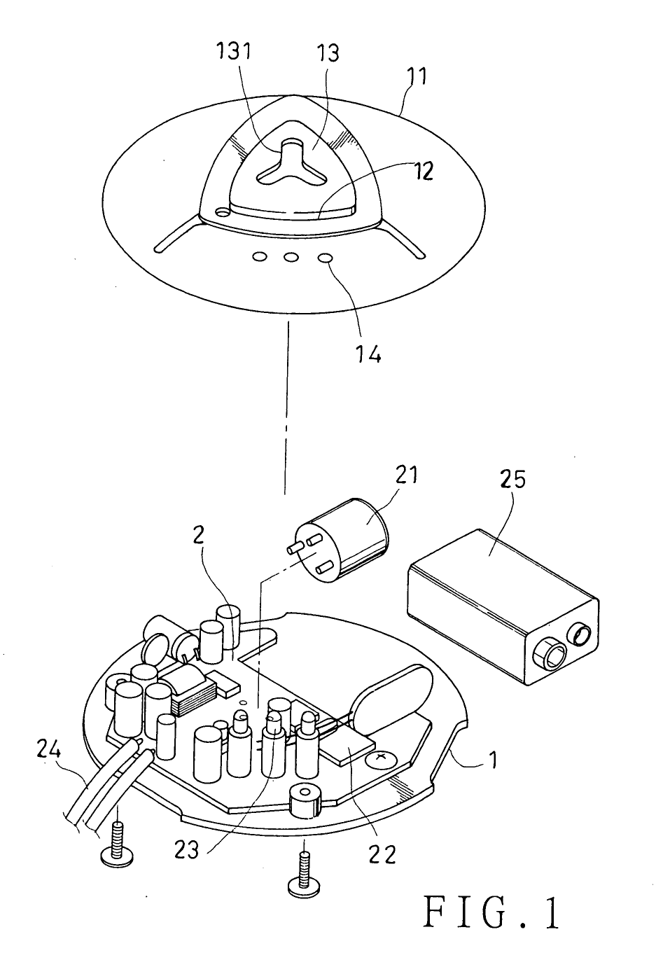

Referring to FIG. 1, a first preferred embodiment of a detecting and measuring device of the present invention includes a base member 1, and a circuit board 2.

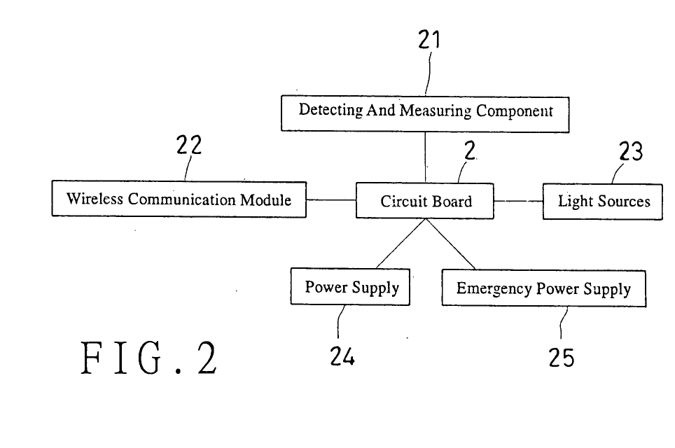

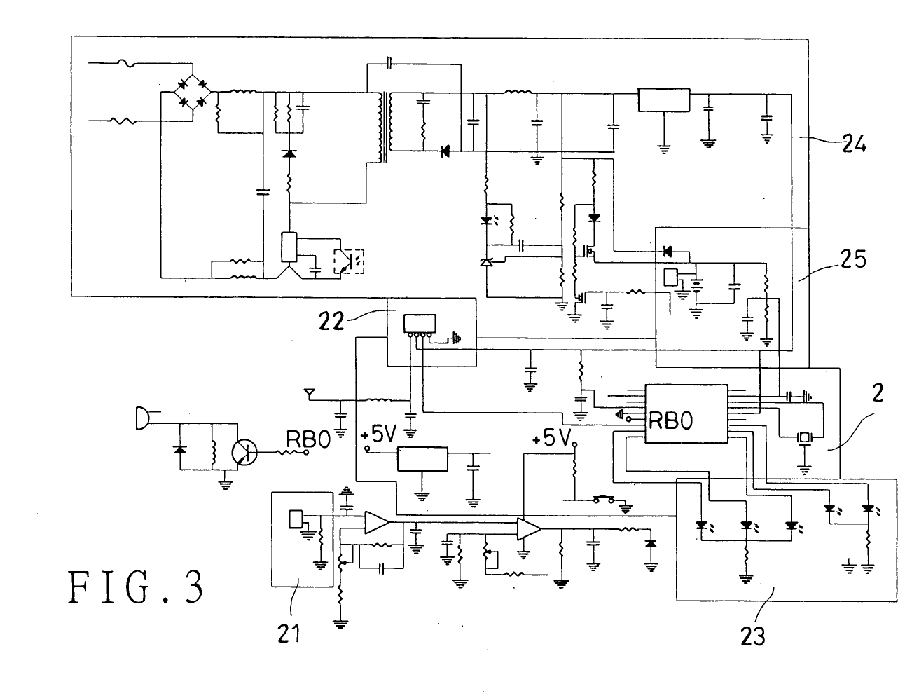

A detecting and measuring component 21 is fitted on a middle portion of the circuit board 2 in such a manner as to be easily replaceable. Referring to FIGS. 2 and 3 as well, a wireless communication module 22 is connected to the detecting and measuring component 21. Several light sources 23 are fitted on the circuit board 2 to indicate that the detecting and measuring component 21 is functioning in a normal manner; the light sources 23 can be light emitting diodes (LED); if the detecting and measuring component 21 is damaged, the light sources 23 will emit red light so that the user will notice, and replace the damaged detecting and measuring component 21 with a new one.

The detecting and measuring component 21 is connected to a power supply 24. Furthermore, the detecting and measuring component 21 is connected to an emergency power supply 25 such as a replaceable battery; thus, the present detecting and measuring device will continue functioning even if power failure occurs.

A covering member 11 is secured on the base member 1. The covering member 11 has an opening 12 on a middle portion thereof. A movable lid 13 is fitted on the opening 12 of the covering member 11 therefore a person is allowed to replace the detecting and measuring component 21 on the circuit board 2 through the opening 12. The movable lid 13 has a hole 131 thereon for air to travel through, and therefore the detecting and measuring component 21 is allowed to carry out a detecting and measuring task easily. Furthermore, the covering member 11 has several holes 14 thereon, which are next to the opening 12 to face the light sources 23 on the circuit board 2; thus, light emitted from the light sources 23 can travel through the holes 14.

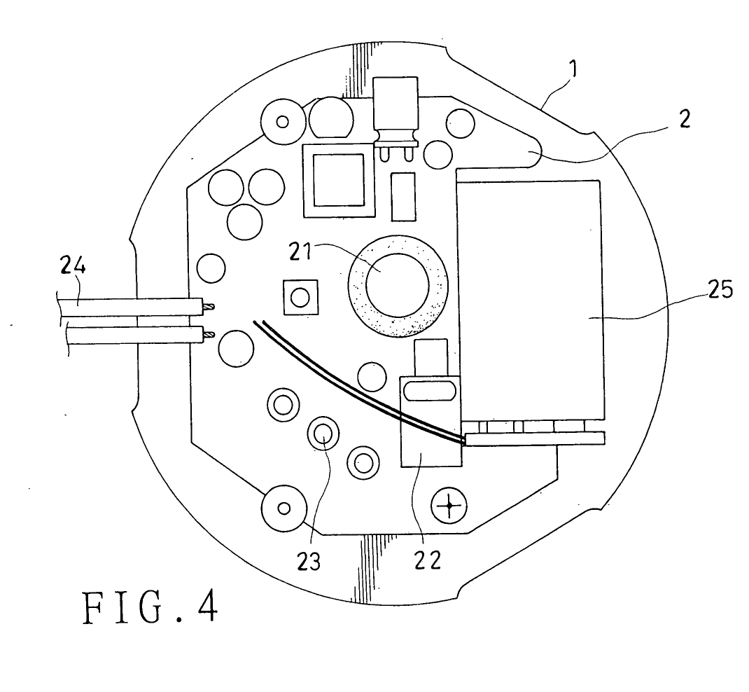

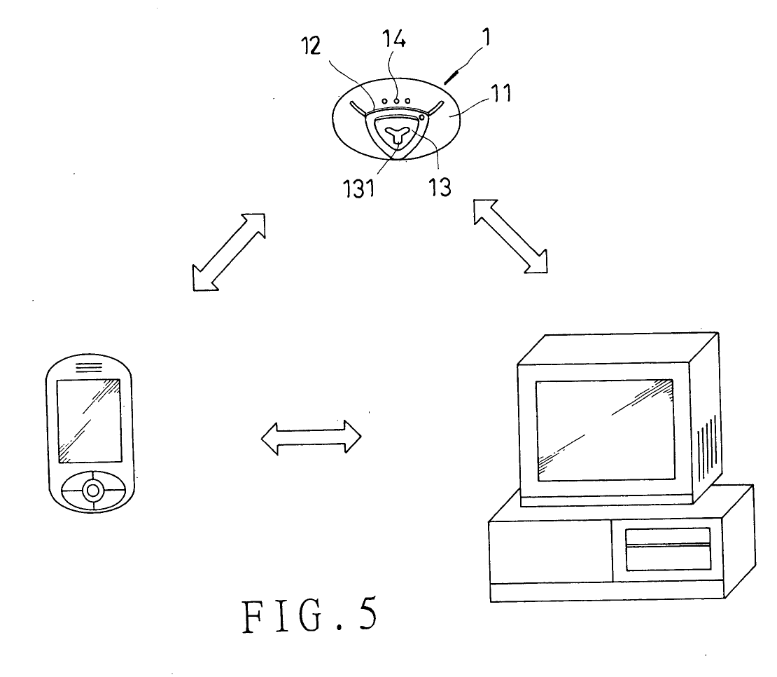

Referring to FIGS. 4 and 5, in assembly and installation, first the circuit board 2 is securely fitted on an upper side of the base member 1, and the covering member 11 is secured to the base member 1 to cover the circuit board 2, with the opening 12 facing the detecting and measuring component 21, and the holes 14 facing the light sources 23 on the circuit board 2; thus, the detecting and measuring component 21 can be easily replaced with another one. Next, the present detecting and measuring device is fitted on a ceiling from a bottom portion of the base member 1, and the power supply 24 is connected to the power system; thus, the present detecting and measuring device will detect and measure oxygen and other data in the surroundings.

Referring to FIGS. 1 and 5, in use, air will travel into the present detecting and measuring device through the hole 131 of the covering member 11, and the detecting and measuring component 21 will continue detecting and measuring the concentration of oxygen and other data in the surroundings. And, the wireless communication module 22 will continue transferring the data obtained through the detecting and measuring component 21 so that the user can receive the data by means of internet in other places or by means of a wireless communication device such as a cellular phone at a distance away. Consequently, the user doesn't have to stay near to the detecting and measuring device. Furthermore, the user is allowed to control the power supplies of various electric appliances through the circuit board 2. In other words, the user can turn on and turn off the various electric appliances at a distance away; if abnormal conditions occur, the light sources 23 will emit red light to make the user notice, and the wireless communication module 22 will send signals to the user; thus, the user can turn off the electric appliances in time to prevent danger through the circuit board 2 at a distance away.

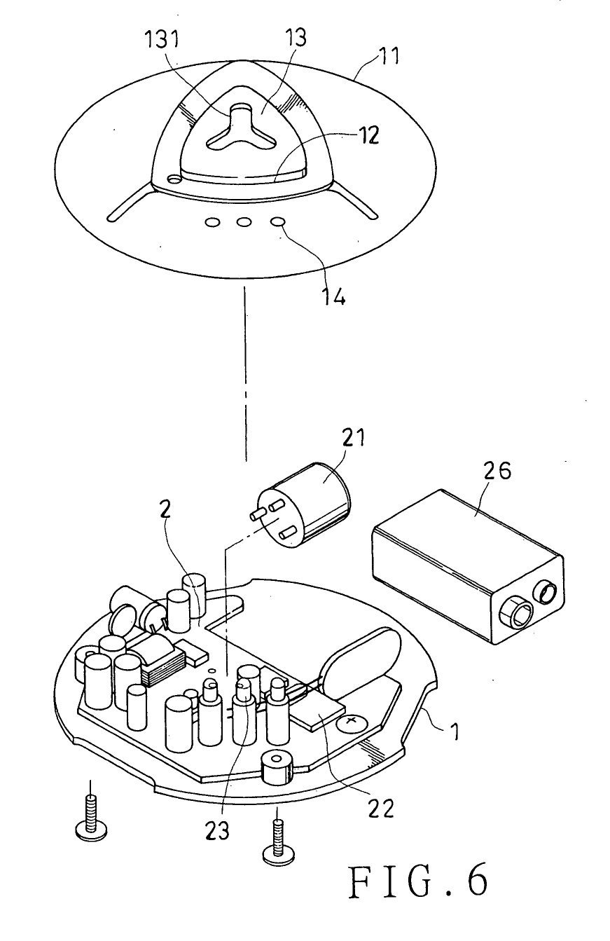

Shown in FIG. 6 is the second preferred embodiment of a detecting and measuring device of the present invention. The second embodiment is basically the same as the first one, yet the circuit board 2 of the second embodiment has single power supply 26, which is a replaceable battery; the user is allowed to carry the present detecting and measuring device with him, and install the device in any place. After having obtained data with the present device, the user can remove the present device, and install it at another place to carry put the next detecting and measuring task.

From the above description, it can be seen that the detecting and measuring device of the present invention has the following advantages over the prior art:

2. The circuit board of the present device is equipped with the wireless communication module to take the place of the wired system such as connecting lines/internet interfaces. Consequently, less hardware is used with the present device, and it takes less expense to manufacture, install and maintain the present invention.

3. The present device is relatively convenient to use; the detecting and measuring component will continue carrying out the detecting and measuring task, and the wireless communication module will continue transferring the data obtained through the detecting and measuring component. Therefore, while being a distance from the present device, the user can receive the data through internet in other places or by means of a wireless communication device such as a cellular phone at a distance away. In other words, the user doesn't have to be near to the detecting and measuring device always.

3. The present device is relatively economical to use; the volume of hardware used with the present invention is relatively small, and the expense is relatively low. And, single receiving platform can be used with several such wireless communication modules; the user is allowed to monitor the oxygen concentration and other data in many different places in a large-scaled factory with the present invention.

4. The circuit board of the present device is connected to an emergency power supply such as a replaceable battery. Therefore, the present detecting and measuring device will continue functioning even if power failure occurs. At the same time, the wireless communication module will send out signals to indicate to the distant user that an abnormal condition has occurred to the circuit.

5. The circuit board of the present device can be used to control the power supplies of various electric appliances. Furthermore, because the circuit board is equipped with the wireless communication module, it can be used to turn on the power supplies of the electric appliances by the user at a distance away. And, when abnormal conditions occur, the user can turn off the electric appliances in time to prevent accidents through the circuit board at a distance away.

6. The circuit board of the detecting and measuring device of the present invention can be powered with batteries. Therefore, the present device is convenient to use, capable of being easily carried to and installed in any place.

What is claimed is:

1. A detecting and measuring device, comprising
a base member,
a circuit board secured on the base member, the circuit board having a detecting and measuring component fitted thereon; the circuit board being connected to a power supply; and
a wireless communication module fitted on the circuit board.

2. The detecting and measuring device as claimed in claim 1, wherein at least one light source is fitted on the circuit board.

3. The detecting and measuring device as claimed in claim 2, wherein the light source is a light emitting diode.

4. The detecting and measuring device as claimed in claim 1, wherein the power supply is a battery.

5. The detecting and measuring device as claimed in claim 1, wherein the circuit board is connected to an emergency power supply.

6. The detecting and measuring device as claimed in claim 5, wherein the emergency power supply is a battery.

7. The detecting and measuring device as claimed in claim 1 further comprising a covering member, which is secured on the base member to cover the circuit board.

8. The detecting and measuring device as claimed in claim 7, wherein the covering member has a plurality of holes for light to travel through.

9. The detecting and measuring device as claimed in claim 7, wherein the covering member has an opening, and a movable lid is fitted on the opening.

10. The detecting and measuring device as claimed in claim 9, wherein the movable lid has a hole thereon.
